(19) United States
(12) Patent Application Publication
(10) Pub. No.: US 2006/0278693 A1
(43) Pub. Date: Dec. 14, 2006

(54) DYNAMIC INCLUSION OF SECURITY FEATURES UPON A COMMERCIAL INSTRUMENT SYSTEMS AND METHODS

(75) Inventors: Robert Alan Stier, Papillion, NE (US); Glen David Wordekemper, Omaha, NE (US); Kelly Liberty, Omaha, NE (US); Sandra Sue Haugen, Papillion, NE (US); William Hickox, Omaha, NE (US); Michelle Marie Ellwanger, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/422,943

(22) Filed: Jun. 8, 2006

Related U.S. Application Data
(63) Continuation-in-part of application No. 11/152,040, filed on Jun. 13, 2005.

(51) Int. Cl. G07F 19/00; G06F 15/12

(52) U.S. Cl. 235/379; 235/432

(57) ABSTRACT

Systems and methods are described for determining security features to be included upon a commercial instrument. Security features are dynamically selected for inclusion on a particular commercial instrument based on the characteristics of the customer, as applied to the security criteria related to the particular instrument. The selected security features are printed on the applicable instrument, and this process of dynamic selection and printing may be repeated for each of a number of additional instruments.

### CROSS-REFERENCE TO RELATED APPLICATIONS

This application is a continuation-in-part from U.S. patent application Ser. No. 11/152,040, filed Jun. 13, 2005, entitled “STRATEGIC COMMUNICATIONS SYSTEMS AND METHODS” which is hereby incorporated by reference, as if set forth in full in this document, for all purposes.

### FIELD OF THE INVENTION

The present invention relates to commercial instruments in general and, in particular, to the dynamic inclusion of security features thereon.

### BACKGROUND OF THE INVENTION

Companies and organizations produce and utilize a wide range of commercial instruments. Such instruments may include, for example, checks, cashier's checks, money orders and other negotiable instruments. In addition, other types of commercial instruments include insurance, mortgage, title and other legal documents.

Because of fraud concerns, security features are often integrated into the instruments. Improvements in printing technology have allowed such features to be included on a broader range of instruments. For example, magnetic ink, color ink, and void pantographs are standard features in an ever increasing range of documents. However, the inclusion and monitoring of such security features can be costly.

Moreover, different types of commercial instruments often have varied security concerns. Different transactions also may have a range of valuations and fraud risks. These risks also may vary substantially for customers of different financial profiles. Moreover, different financial institutions may have varied risk tolerances, and preferred security features. Clearly, there are a broad range of commercial instruments, with an even broader range of security issues.

Traditionally, a discrete set of security features was printed into a given type of commercial instrument from a single institution, and there was limited flexibility. Often, to lower costs, larger production runs were undertaken to integrate the security features into a given type of commercial instrument. This in many cases made the cost of including different security features in limited, or select, instruments prohibitive. It, therefore, would be desirable to enhance the ability to dynamically include security features in commercial instruments printed depending on the company, customer, risk profile or other applicable criteria.

### BRIEF SUMMARY OF THE INVENTION

Various embodiments of the invention comprise systems and methods for determining security features to be included upon a commercial instrument. In one exemplary embodiment, security features are dynamically selected for inclusion on a particular commercial instrument based on the characteristics of the customer, as applied to the security criteria related to the particular instrument. The selected security features are printed on the applicable instrument, and this process of dynamic selection and printing is repeated for each of a number of additional instruments.

One exemplary embodiment of the invention comprises a system for dynamically selecting security features for inclusion in a commercial instrument. This embodiment includes a rules data store containing criteria for printing security features on a commercial instrument. It also includes a customer data store defining characteristics of a plurality of customers. A decision engine is configured to determine the subset of security features to be included on a commercial instrument, based at least in part on matching the criteria to the characteristics of the customer. The determination of the subset of security features may also be based in part on the value of the transaction. The decision engine is configured to repeat this process and thereby identify the security features applicable to other commercial instruments for additional customers by matching the different characteristics of each customer to the criteria. A composition engine is configured to format the subset of security features for the commercial instrument.

In one embodiment the system further includes a printer configured to print the subset of security features for the commercial instrument. There are a number of security features that may be printed. For example, the printer may include a magnetic ink module (e.g., a MICR module) configured to selectively apply magnetic ink to the commercial instrument. The printer may also include a selective perforation module to selectively add a perforation to the commercial instrument. The printer may include one or more color ink modules to selectively apply color ink to the commercial instrument. The printer may be configured to print a void pantograph, microprint, a decorative border, or embedded machine-readable data. Additionally, the decision engine may calculate a unique number (e.g., perform a hash function) based on a check number, a transaction amount, a date of issue, or other information in the commercial instrument.

The printer, in one embodiment, is configured to receive paper from a roll, and print a number of distinct commercial instruments for each of the plurality of customers in successive order. Paper may comprise a preprinted commercial instrument, or the printer may be configured to print both the commercial instrument and the subset of security features. The decision engine and composition engine may together comprise a single host computer.

Criteria for including security features on a commercial instrument may include a credit rating, credit balance, other financial rating, account balance, account type, zip code, other geographic criterion, transaction value, or transaction amount. A commercial instrument may, for example, comprise a check, money order, other negotiable instrument, insurance document, mortgage document, title document, prescription, envelope, or other legal or financial document.

Another exemplary embodiment of the invention comprises a method of dynamically determining a subset of security features to be printed upon a commercial instrument. In this embodiment, criteria for printing the security features on a commercial instrument are received. Characteristics of a customer are matched to the criteria to identify the subset of the security features. The subset of the security features for the commercial instrument is then printed. In one embodiment, the process is repeated, and characteristics of a plurality of additional customers are matched to the criteria to identify additional subsets of the security features for each customer. The additional subsets of security features for each are then printed on a series of commercial instruments.

In this embodiment, the printing of the security features may include applying magnetic ink, perforating the commercial instrument, applying color ink to the commercial instrument, or calculating a unique number for printing on the commercial instrument. The security features may be printed on paper received from a roll. The paper may comprise preprinted commercial instruments, or the commercial instruments may be printed thereon.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram illustrating a system for determining security features to be included upon a commercial instrument according to various embodiments of the present invention.

FIG. 2 is a block diagram illustrating a system to determine security features to be printed upon a commercial instrument according to various embodiments of the present invention.

FIGS. 3A and 3B are exemplary tables illustrating the application of criteria to characteristics of a customer, according to various embodiments of the present invention.

FIG. 4 is a block diagram illustrating an exemplary printer configured according to various embodiments of the present invention.

FIG. 5 is a block diagram illustrating an exemplary printer output according to various embodiments of the present invention.

FIG. 6 is a flowchart illustrating a method to determine security features to be printed upon a commercial instrument according to various embodiments of the present invention.

FIG. 7 is a flow chart illustrating an alternative method to determine security features to be printed upon a commercial instrument according to various embodiments of the present invention.

FIG. 8 is a schematic diagram that illustrates a representative device structure that may be used in various embodiments of the present invention.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention as set forth in the appended claims.

Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner.

It should also be appreciated that the following systems and methods may be a component of a larger system, wherein other procedures may take precedence over or otherwise modify their application. Also, a number of steps may be required before, after, or concurrently with the following embodiments.

Systems and methods are described for determining security features to be included upon a commercial instrument. Security features are dynamically selected for inclusion on a particular commercial instrument based on the characteristics of a customer, as applied to the security criteria related to the particular instrument. The selected security features may then be printed on the applicable instrument, and this process of dynamic selection and printing may be repeated for each of a number of additional instruments.

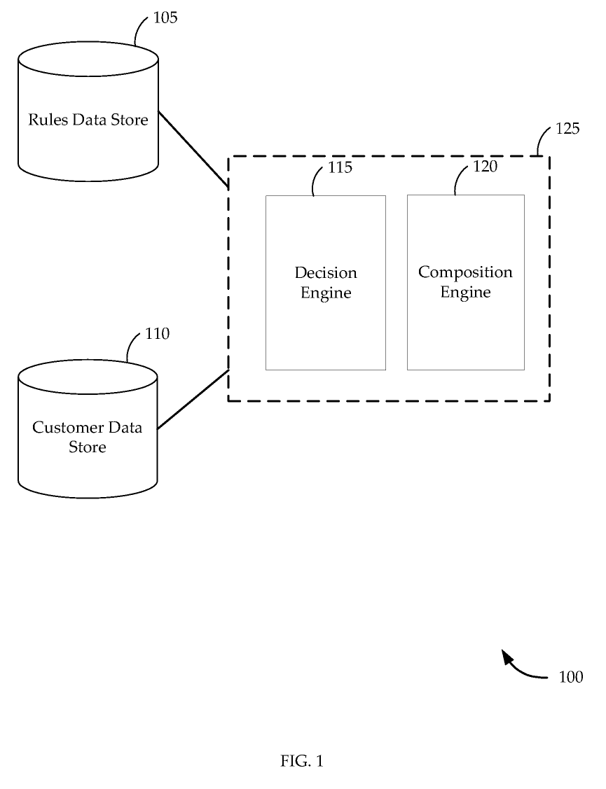

FIG. 1 illustrates an exemplary embodiment of the invention comprising a system 100 for dynamically determining a subset of security features to be included on a commercial instrument. The system includes a rules data store 105 comprising criteria for printing the security features on a commercial instrument. Each set of criteria may apply to commercial instruments produced for the customers of one, or more, companies. For example, a first set of criteria may apply to commercial instruments produced for only one financial institution (e.g., Bank XYZ), while a second set of criteria may apply to the customers of a number of different companies (e.g., Mortgage Company A, Title Company B, Bank C). A company may specify criteria for printing security features on commercial instruments for different customers, such as credit rating, credit balance, other financial ratings, account balance, account type, zip code, other geographic criteria, value of the commercial instrument, transaction value, transaction amount, or any combination these factors. Merely by way of example, for customers in certain ranges of credit ratings, more or fewer security features may be desirable. Similarly, more security features may be included for customers residing in certain high crime areas. The criteria may also be related to the legal implications of the commercial instrument (e.g., insurance agreement vs. property title work).

Each set of criteria may also apply to one, or more, types of commercial instruments. A commercial instrument may comprise a check, money order, cashier's check, insurance document, mortgage document, title document, prescription, or other legal or negotiable instrument. A commercial instrument may also comprise an envelope associated with another commercial instrument (e.g., an envelope in which a particular instrument will be sent). A given set of criteria may, therefore, apply to only certain types of commercial instruments, for a given subset of companies. The rules data store may store information identifying the dimensions and specification for each type of commercial instrument from each company. However, there may be universal rules, as well.

The system 100 further includes a customer data store 110, including data defining characteristics of a number of customers. A customer may comprise an individual, but may alternatively comprise a corporation, organization, or other entity. A customer data store 110 may contain a broad range of data related to each customer. For example, it may contain primary information to be included on a commercial instrument (e.g., name, address, telephone number, social security number, etc.). A customer data store 110 may also include customer data to compare to the criteria to determine the appropriate security features for a particular commercial instrument. Thus, for a given customer, the customer data store 110 may include listings for a credit rating, credit balance, other financial rating, account balance, account type, zip code, or other geographic criteria. It may also include a transaction history, listing purchase of particular items, total amount of purchases over a predetermined time period, merchants from which goods or services were purchased, or any other type of transaction history. Moreover, it may contain information relating to the type or types of commercial instrument to be printed for a customer, and information identifying accounts/companies associated with the customer.

Customer data store 110 may also include other background information (e.g., household income, age, gender, marital status, number of children, credit rating, associated account information (e.g., mortgage account information, credit card account information, savings account information, checking account information, etc.)). Customer data store 110 may also contain other attributes about a customer that may be used to determine whether to include certain security features on a commercial instrument. This information may be provided from one or more sources (e.g., credit card issuers, utility providers, market analyzers, etc.).

In some embodiments, the data stores 105, 110 comprise a single database, while in other embodiments, they may comprise any number of separate and distinct databases. The rules data store 105 and the customer data store 110 may together comprise one, or more, relational databases or components of relational databases (e.g., tables), object databases or components of object databases, spreadsheets, text files, internal software lists, or any other type of data structure suitable for storing data. Thus, it should be appreciated that data stores 105, 110 may each be multiple data storages (of the same or different type), or may share a common data storage with other data stores.

The rules data store 105 and the customer data store 110 interact during the creation and formatting of commercial instruments. They may, therefore, be integrated directly, or through one or more intermediate computing devices configured to query the rules to identify security features applicable to a particular customer.

In this exemplary embodiment, a decision engine 115 is configured to determine the subset of security features to be included on a commercial instrument for an identified customer. The decision engine 115 identifies the security features to be included based at least in part on matching the characteristics of a particular customer (or set of customers) retrieved from the customer data store 110 to the criteria set forth in the rules data store 105. The decision engine 110 may receive an identification of a customer from a variety of different input sources (e.g., local, remote, web-based interface, etc.). The input may also identify the type of instrument to be printed, and the applicable company/account, or this information may be stored in and retrieved from the customer data store 110.

There are a number of security features which may be dynamically included upon a commercial instrument according to various embodiments of the invention, including one or more of the following:
Account Number Verification: The Account Number from the MICR line may be printed on the document (e.g., beneath a fractional routing transit symbol).
“Amount in Words” Legal Amount Field: A specific area on the check may be allocated to print the express value of the check in words.
Check Digit Validation: A hash function or other mathematical formula may use data elements, such as check number, amount, and date of issue, to create a unique number that can be printed in the MICR codeline, or elsewhere.
Colored Ink: One or more ink colors other than black may be applied.
Decorative Border: Border designs may comprise a simple or more elaborate network of fine lines arranged into tightly spaced flourishes.
Document Fraud Deterrent Icon: A Deterrent Icon may be utilized to detect the presence of security technologies used to prevent copying, alterations, casual counterfeiting or the use of any fraudulent methods of defrauding the author or paying financial institution. This icon is represented as the “lock” or other icon. In one embodiment, it may be used when both of the following conditions are met:
   1. The presence of a minimum of 3 features, and
   2. The features selected defend against both alteration and counterfeiting collectively.
      Other types of document fraud deterrent icons may be used as well, as evident to those skilled in the art.
Embedded Data: Information comprising embedded data may be added to a document, which is intended to be machine-readable, and not human processed. Examples of embedded data are bar codes (code 3×9, code 128), two dimensional bar codes, and dataglyphs.
Magnetic Ink: Ink may be used that contains an amount of iron (or other magnetic material) to magnetize the print when exposed to a magnetic field (e.g. MICR).
Microprint: Text may be set in very small letters (e.g., less than 0.0010″ tall) that can be read through a magnifying glass, but may appear to the unaided eye to be dashed, or solid, lines.
Perforation: Each instrument may be selectively perforated. The perforation may be selectively applied in a pattern or manner that cannot be detected or copied by a copier or similar device, or is otherwise non-reproducible.
Void Pantograph: A background area on the commercial instrument, upon which a hidden word or message will appear when copied or otherwise reproduced.
   There may be one, or more, levels of security for each of the above listed security features, and the security features may be otherwise modified or adapted to serve specific companies. A variety of other security features are known in the art, and may be used in addition to those specified above.

Thus, the decision engine 115 determines one or more security features to be included upon the commercial instrument for a given customer (or set of customers). The composition engine 120 is configured to format or select the information to use for the commercial instrument based, at least in part, on the type of commercial instrument to be output. Merely by way of example, the composition engine 120 may be configured to include a security feature in different ways, depending on the type of commercial instrument. The composition engine 120 may determine not to include a particular security feature if there is insufficient space available. The composition engine 120 is, therefore, configured to produce printable image data comprising any portion of the commercial instrument, the security features, or both.

In this embodiment, the decision engine 115 and the composition engine 120 together comprise a host computer system 125. The decision engine 115 and the composition engine 120 may, therefore, be implemented as logic components comprising one or more software programs, one or more components of a software program (e.g., function or program object), firmware, or other type of machine-executable instructions. The host computer system 125 may include, for example, one or more server computers, personal computers, workstations, web servers, or other suitable computing devices. The host computer system may be fully located within a single facility or distributed geographically, in which case a network may be used to integrate different components. Application software running on the host computer system 125 may receive an input and identify customer characteristics from the customer data store 110. Using these characteristics, this software may query the rules data store to identify the applicable security features associated with the customer, commercial instrument type, and sponsoring entity. This software may then produce image data comprising the selected security features to be sent to the printer. In other embodiments, the decision engine 115 and the composition engine 120 may comprise independent servers or other computing devices.

It should be appreciated that the components of the system 100 may perform additional, fewer, or alternative functions than those described above. It should also be appreciated that the system 100 may include additional, fewer, or alternative components than those illustrated in FIG. 1.

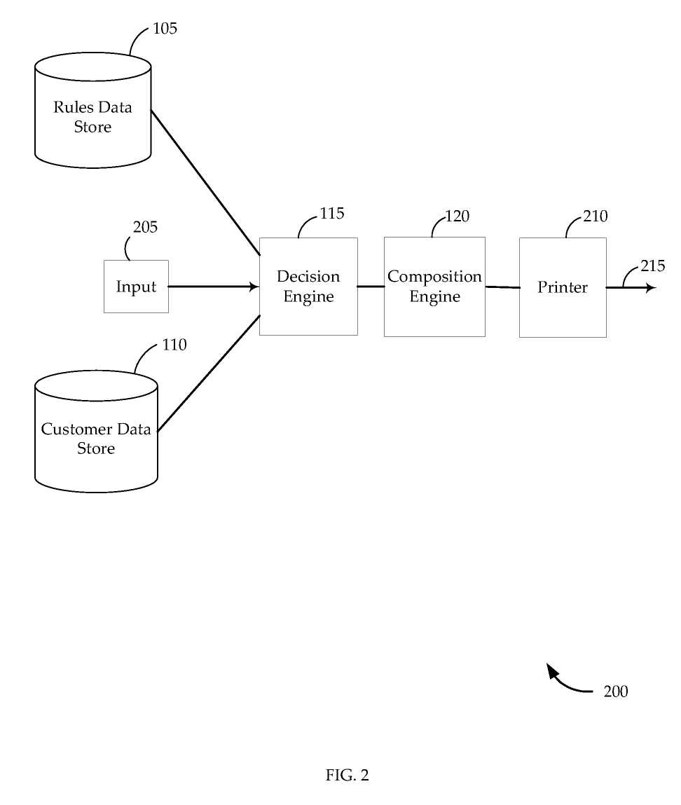

FIG. 2 illustrates an alternative embodiment of the invention comprising an exemplary system 200 for dynamically determining a subset of security features for printing upon a commercial instrument. This system 200 includes a rules data store 105, customer data store 110, decision engine 115, and composition engine 120. Therefore, it may comprise the system 100 described above for FIG. 1, with the following additions.

Specifically, this system 200 includes an input source 205, which may comprise an automatic or manual entry from a local, remote, or web-based source. In this embodiment, the input source 205 identifies a customer within the customer data store 110 for whom the commercial instrument will be printed. The input source 205 also identifies the type of instrument, and the company or other organization for which the instrument will be printed. The input may further include information related to the value of commercial instrument to be produced. In other embodiments, the input may provide any subset of this information, with the remainder drawn from the customer data store 110, or elsewhere. The decision engine 115 queries the customer data store 110 to retrieve the characteristics of the customer (or, perhaps, set of customers), and applies these characteristics (and perhaps certain input information) to the criteria set forth in the rules data store 105 to identify the security features to be applied.

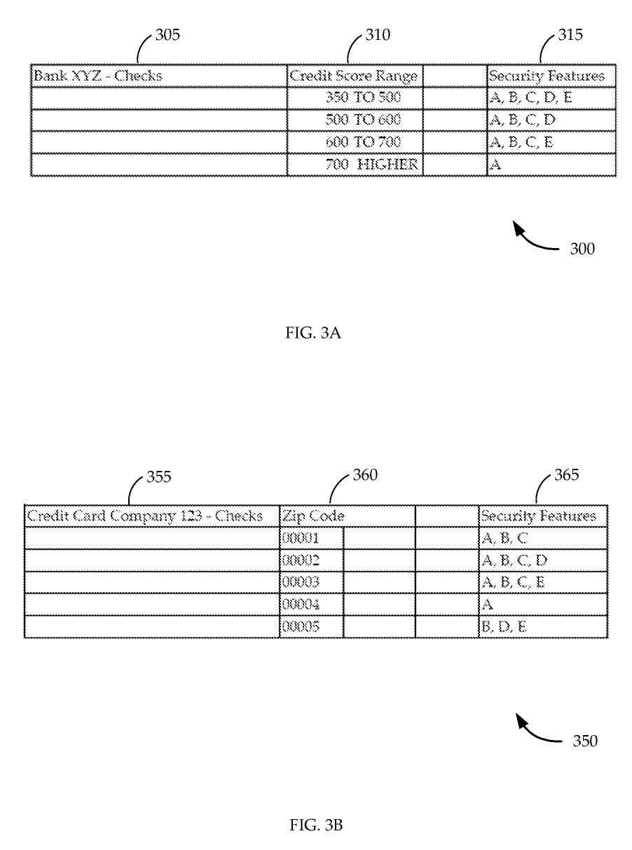

FIGS. 3A and 3B illustrate tables 300, 350 provided for exemplary purposes only, showing how the rules data store 105 content may be structured according to certain embodiments of the invention. Certain contents of the tables described below may, in other embodiments, not be stored in the rules data store 105 and, instead, may be stored elsewhere on a temporary or more permanent basis.

Turning to the table 300 of FIG. 3A, column 305 identifies 1) the applicable financial institution “Bank XYZ” and 2) the type of commercial instrument, “Checks.” Column 310 lists ranges of credit scores, and column 315 lists generic security features to be included. In essence, column 310 sets forth criteria (i.e., credit score ranges) from which certain corresponding security features will be selected, for checks at Bank XYZ. It is worth noting that while in this embodiment, a single bank and type of commercial instrument are identified, in other embodiments a set of criteria may apply to sets of financial institutions, types of commercial instruments, sets of customers, or any combination thereof.

Table 350 of FIG. 3B, column 355 identifies 1) the applicable financial institution “Credit Card Company 123” and 2) the type of commercial instrument, “Checks.” Column 360 lists ranges of zip codes, and column 365 lists generic security features to be included. In essence, column 360 sets forth criteria (i.e., zip code ranges) from which certain corresponding security features will be selected, for checks at Credit Card Company 123. While in these embodiments, security features are identified based on a single set of criteria (i.e., credit scores or zip codes), one skilled in the art will recognize that in other embodiments a number of sets of criteria may be combined to select applicable security features.

Returning to FIG. 2, once the decision engine 115 selects the applicable security features, the composition engine 120 formats the commercial instrument accordingly to create one or more sets of image data. The image data is forwarded from the composition engine 120 to printer 210, to print the sets of image data. Printer 210 may be physically located next to the decision engine 115, the composition engine 120, or both; alternatively, the printer may be located remotely from the other components, and simply connected via a network. Printer 210 may be configured to selectively add the identified and formatted security features, such as perforations, MICR information, and color components to the commercial instrument, in accordance with the format option of the instrument at issue. Therefore, the security features to be printed on a commercial instrument may vary on a per check, or per customer, basis. Security features may be added dynamically, depending upon the criteria set forth in the rules database.

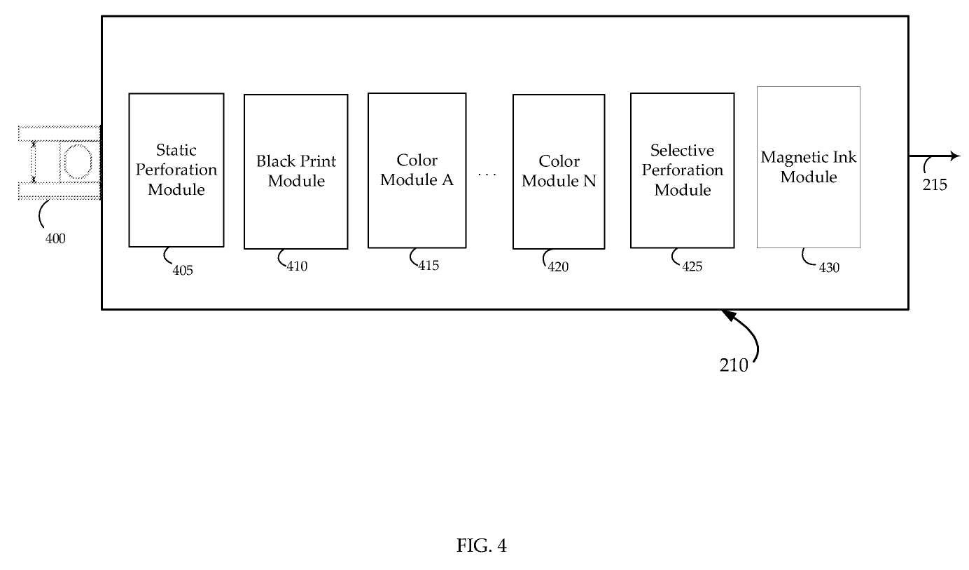

FIG. 4 illustrates an exemplary embodiment of the printer 210 configured according to various embodiments of the invention. The printer 210 includes an unwind module 400 for a paper roll, a static perforation module 405, a black print module 410, one or more color modules 415, 420, a selective perforation module 425, and a magnetic ink (e.g., MICR) module 430. These modules may be arranged in any suitable fashion, and may be used in various combinations to apply the security features set forth in paragraph [0034].

The static perforation module 405 may be used to add perforations common to all recipients (e.g., a remittance perforation). Black print module 410 may add black or grayscale text or components to a correspondence (e.g., the black print module may print the unique number/hash described above). Color modules 415, 420 may be used to selectively apply color to a commercial instrument based on the format of the recipient's correspondence. Unlike certain traditional solutions, which apply color with a static press, the color included on a commercial instrument for a correspondence job may vary from customer to customer, and therefore from instrument to instrument.

Selective perforation module 425 may be used to selectively add perforations to a recipient's correspondence. Perforation may comprise cutting, a pierced row of holes to facilitate tearing, or other cuts or holes in patterns for security purposes. The selective perforation module 425 may include adjustable perforation wheels for in-line continuous or jump perforating, or other types of perforation as known in the art. In contrast to certain traditional solutions, the perforations on each commercial instrument may be different from others. This may allow the system 200 to select and format each instrument so that certain instruments are bordered by perforations to provide unique security features.

The magnetic ink module 430 may selectively add magnetic ink (e.g., MICR information) to commercial instruments. The use of the printer 210 with a selective magnetic ink module may allow checks, or other types of components using MICR information, to have magnetic ink added to a select number of commercial instruments. The magnetic ink module 430 may be configured in any manner known in the art.

In other embodiments, printer 210 may include additional, or fewer, components than those shown in FIG. 4. For example, printer 210 may not include a magnetic ink module 430 or selective perforation module 425. Other variations are contemplated, and a variety of printer configurations may be used with the scope of the invention. The printer 210 prints the identified security features upon the commercial instrument. The printer may receive a preprinted commercial instrument, or may be configured to print all or part of the commercial instrument as well. The printer 210 produces an output 215, comprising a commercial instrument including the subset of security features.

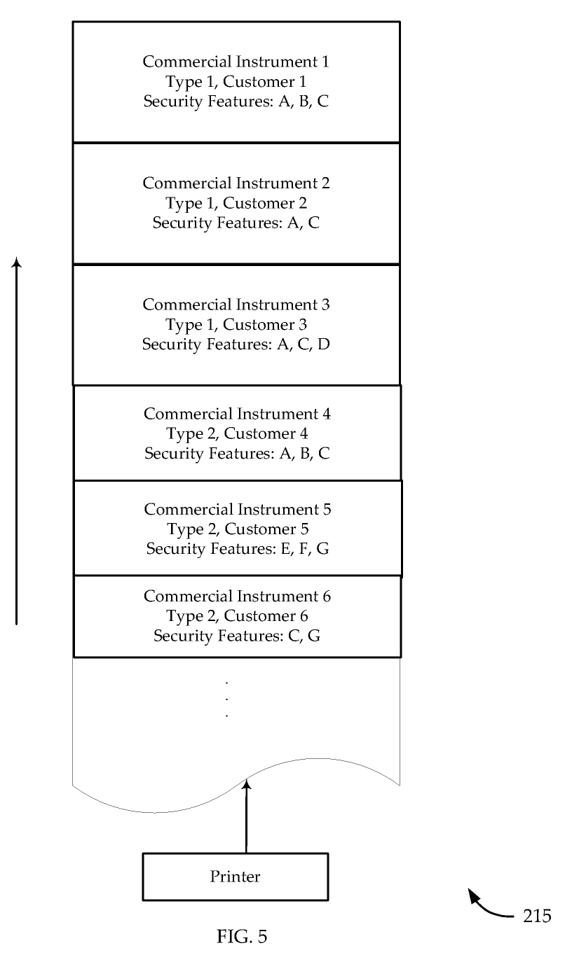

FIG. 5 is a block diagram illustrating an exemplary output 215 from a printer configured according to various embodiments of the invention (this printer may comprise the printer 210 of FIG. 4). In this embodiment, the output 215 comprises a single sheet of paper received by the printer from a roll, with a number of commercial instruments printed in successive order.

The output 215 of FIG. 5 illustrates how a printer may be configured to produce commercial instruments of the same type (Type 1), yet with different security features for different customers (e.g., commercial instruments 1, 2, 3). The printer may then dynamically produce a different type of commercial instrument (Type 2), with still different sets of security features for different customers. In this embodiment one may assume that the criteria apply to commercial instruments produced for a single company. However, in other embodiments, sets of criteria may apply to only more than one company. Moreover, criteria may be developed to have alternative sets of criteria applicable to different companies , so that different security features might be identified for the same customer and instrument type.

In other embodiments, other printing material may be used instead of or in conjunction with, paper. Also, instead of receiving paper from a roll (e.g., continuous feed), individual sheets (e.g., cut sheets) of paper may be received and output. While the printer may also include additional mechanisms to cut paper to form discrete commercial instruments, this function may be performed by other components, as well.

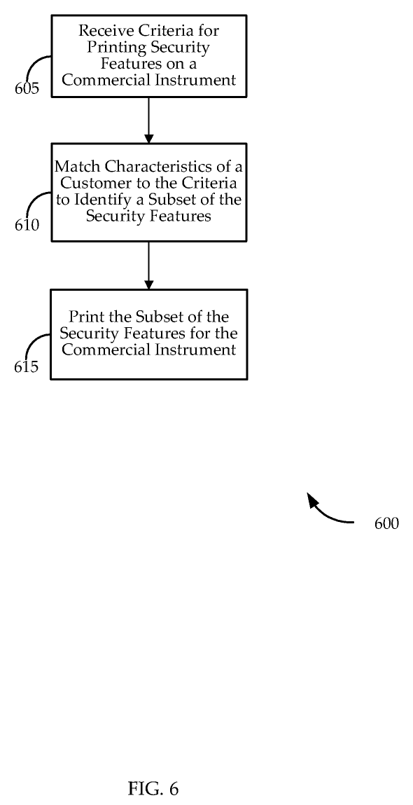

FIG. 6 sets forth an exemplary embodiment 600 of the invention, illustrating a method for dynamically determining a subset of security features to be printed upon a commercial instrument. At block 605, criteria for printing security features on a commercial instrument are received. At block 610, characteristics of a customer are matched to the criteria to identify a subset of the security features. At block 615, the subset of the security features for the commercial instrument is printed.

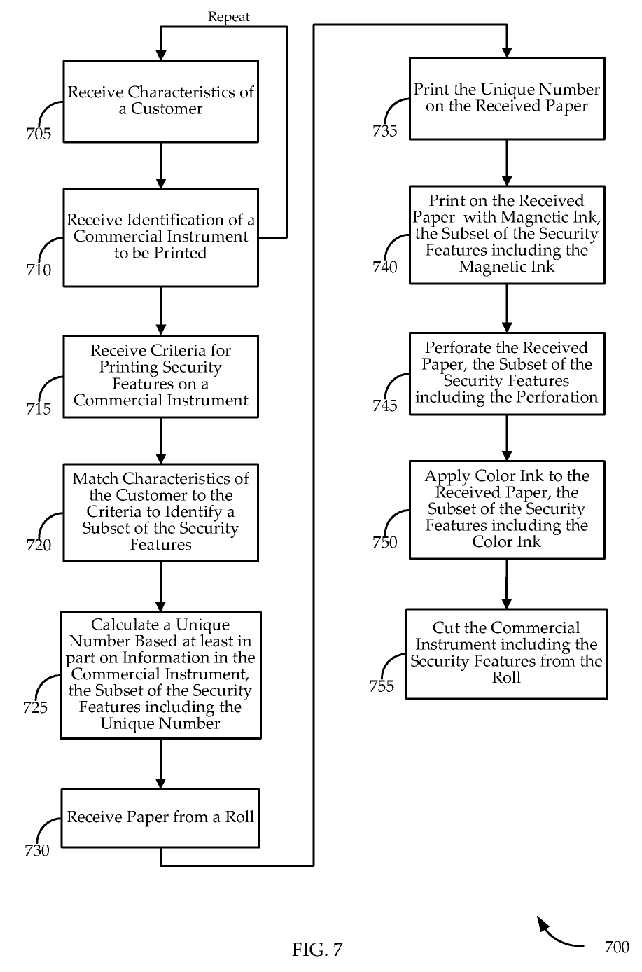

FIG. 7 sets forth an alternative embodiment 700 of the invention, illustrating an exemplary method for dynamically determining a subset of security features to be printed upon a commercial instrument. At block 705, characteristics of a customer are received. At block 710, an identification of a type of commercial instrument to be printed is received. With the customer characteristics and type of instrument identified, blocks 715-755 are then undertaken for the identified customer characteristics and type of instrument. Blocks 705 and 710 may be repeated for any number of customers or commercial instruments, and then blocks 715-755 may be undertaken for each respective set of identified customer characteristics and instrument type.

Criteria for printing security features on a commercial instrument are then received at block 715. At block 720, the characteristics of the customer are matched to the criteria, to identify a subset of the security features. At block 725, a unique number (e.g., a hash) is calculated based at least in part on information in the commercial instrument, wherein the unique number is one of the subset of the security features. Paper is received from a roll at block 730, and at block 735 the unique number is printed on the received paper. At block 740, the received paper is printed with magnetic ink (e.g., MICR), wherein the magnetic ink is one of the security features. At block 745, the received paper is perforated, wherein the perforation is one the subset of the security features. At block 750, color ink is selectively applied to the received paper, wherein the color ink is one the subset of the security features. At block 755, the commercial instrument, including the security features, is cut from the roll.

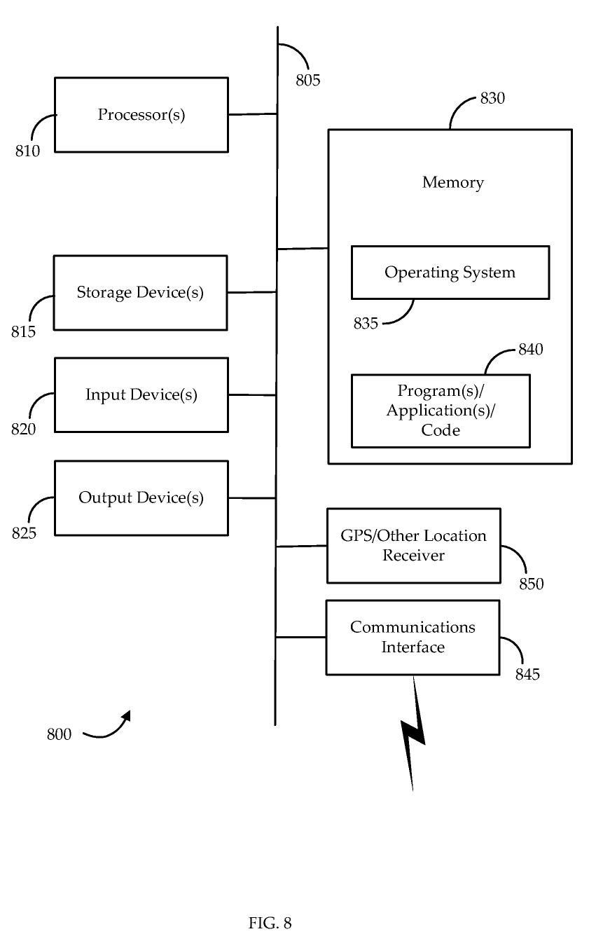

A device structure 800 that may be used for a host computer, server, decision engine, composition engine, or other computing device described herein is illustrated with the schematic diagram of FIG. 8. This drawing broadly illustrates how individual system elements of each of the aforementioned devices may be implemented, whether in a separated or more integrated manner. The exemplary structure is shown comprised of hardware elements that are electrically coupled via bus 805, including processor(s) 810 (which may further comprise a DSP or special-purpose processor), storage device(s) 815, input device(s) 820, and output device(s) 825. The storage device(s) 815 may comprise a computer-readable storage media reader connected to any computer-readable storage medium, the combination comprehensively representing remote, local, fixed, or removable storage devices or storage media for temporarily or more permanently containing computer-readable information. The communications interface 845 may comprise a wired, wireless, or other type of interfacing connection that permits data to be exchanged with other devices. The communications interface 845 may permit data to be exchanged with a network.

The structure 800 may also comprise additional software elements, shown as being currently located within working memory 830, including an operating system 835 and other code 840, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

It should be noted that the methods, systems and devices discussed above are intended merely to be exemplary in nature. It must be stressed that various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure.

Moreover, as disclosed herein, the terms “storage medium” or “storage device” may represent one or more devices for storing data, including read only memory (ROM), random access memory (RAM), magnetic RAM, core memory, magnetic disk storage mediums, optical storage mediums, flash memory devices or other machine readable mediums for storing information. The term “computer-readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be required before the above elements are considered. Accordingly, the above description should not be taken as limiting the scope of the invention, which is defined in the following claims.

What is claimed is:

1. A system for dynamically determining a subset of security features to be printed upon a commercial instrument, the method comprising:
a rules data store including criteria for printing the security features on a commercial instrument;
a customer data store including data defining characteristics of a plurality of customers;
a decision engine, communicatively coupled with the rules data store and the customer data store, configured to determine the subset of security features to be included on a commercial instrument for a customer of the plurality, based at least in part on matching the criteria to the characteristics of the customer; and
a composition engine, communicatively coupled with the decision engine, configured to format the subset of security features for the commercial instrument.

2. The system of claim 1, the system further comprising:
a printer, communicatively coupled with the composition engine, configured to print the subset of security features for the commercial instrument.

3. The system of claim 2, wherein,
the printer includes a magnetic ink module configured to selectively apply magnetic ink to the commercial instrument; and
the subset of the security features includes the selective application of magnetic ink.

4. The system of claim 3, wherein,
the magnetic ink module comprises a MICR module to selectively apply MICR data to the commercial instrument; and
the subset of the security features includes the MICR data.

5. The system of claim 2, wherein,
the printer includes a selective perforation module to selectively add a perforation to the commercial instrument; and
the subset of the security features includes the perforation.

6. The system of claim 2, wherein,
the printer includes one or more color ink modules to selectively apply color ink to the commercial instrument; and
the subset of the security features includes the color ink.

7. The system of claim 2, wherein,
the printer is configured to apply a selection from the group consisting of a void pantograph, microprint, a decorative border, embedded machine-readable data, and any combination thereof; and
the subset of the security features includes the selection.

8. The system of claim 2, wherein the decision engine is configured to identify different security features for each of at least a subset of the plurality of customers, based at least in part on matching different characteristics of each to the criteria.

9. The system of claim 8, wherein the printer is further configured to:
receive paper from a roll;
print on the received paper a distinct commercial instrument for each of the plurality customers, wherein,
each distinct instrument includes the different security features associated with a respective customer; and
each distinct instrument is printed in successive order.

10. The system of claim 2, wherein the printer is further configured to receive a preprinted commercial instrument, and print the subset of security features thereon.

11. The system of claim 2, wherein the printer is further configured to print both the commercial instrument and the subset of security features.

12. The system of claim 1, wherein,
the decision engine is configured to calculate a unique number based at least in part on a selection from the group consisting of a check number, a transaction amount, a date of issue, and any combination thereof; and
the subset of security features includes the unique number.

13. The system of claim 12, wherein the calculation of the unique number comprises a hash function.

14. The system of claim 1, wherein,
the decision engine is further configured to determine the subset of security features to be included based at least in part on a value associated with the commercial instrument.

15. The system of claim 1, wherein,
the criteria apply to a plurality of companies; and
at least a subset of the criteria for printing the security features is applicable to only a preselected type of commercial instrument for a company of the plurality of companies.

16. The system of claim 1, further comprising:
a host computer comprising the decision engine and composition engine.

17. The system of claim 1, wherein the criteria comprise a selection from the group consisting of a credit rating, credit balance, other financial rating, account balance, account type, zip code, other geographic criteria, value of the commercial instrument, transaction value, transaction amount, legal implication, and any combination thereof.

18. The system of claim 1, wherein the commercial instrument comprises a selection from a group consisting of a check, money order, other negotiable instrument, insurance document, mortgage document, title document, prescription, envelope associated with another commercial instrument, other commercial instrument, and any combination thereof.

19. A method of dynamically determining a subset of security features to be printed upon a commercial instrument, the method comprising:
receiving criteria for printing the security features on a commercial instrument;
matching characteristics of a customer to the criteria to identify the subset of the security features;
printing the subset of the security features for the commercial instrument.

20. The method of claim 19, wherein printing the subset of the security features comprises:
printing on the commercial instrument with magnetic ink, the subset of the security features including the magnetic ink.

21. The method of claim 19, wherein printing the subset of the security features comprises:
perforating the commercial instrument, the subset of the security features including the perforation.

22. The method of claim 19, wherein printing the subset of the security features comprises:
applying color ink to the commercial instrument, the subset of the security features including the color ink.

23. The method of claim 19, further comprising:
matching characteristics of a plurality of additional customers to the criteria to identify an additional subset of the security features for each customer of the plurality; and
printing each additional subset of the security features.

24. The method of claim 23, further comprising:
receiving paper from a roll, wherein each additional subset of the security features is printed on the received paper.

25. The method of claim 19, further comprising:
receiving a preprinted commercial instrument, wherein the subset of the security features are printed on the preprinted commercial instrument.

26. The method of claim 19, further comprising:
printing the commercial instrument.

27. The method of claim 19, further comprising:
calculating a unique number based at least in part on a selection from the group consisting of a check number, a transaction amount, a date of issue, and any combination thereof, wherein the subset of security features include the unique number.

28. The method of claim 19, wherein the criteria comprise a selection from the group consisting of a credit rating, credit balance, other financial rating, account balance, account type, zip code, other geographic criteria, transaction value, transaction amount, legal implication, and any combination thereof.

29. A method of dynamically determining a subset of security features to be printed upon a commercial instrument, the method comprising:
receiving criteria for printing the security features on a commercial instrument;
matching characteristics of a customer to the criteria to identify the subset of the security features;
calculating a unique number based at least in part on information in the commercial instrument;
printing the unique number on the commercial instrument;
printing on the commercial instrument with magnetic ink, the subset of the security features including the magnetic ink;
perforating the commercial instrument, the subset of the security features including the perforation; and
applying color ink to the commercial instrument, the subset of the security features including the color ink.
